(19) United States
(12) Patent Application Publication
(10) Pub. No.: US 2007/0202603 A1
(43) Pub. Date: Aug. 30, 2007

(54) APPARATUS AND METHOD FOR SAMPLING AND CORRECTING FLUIDS

(76) Inventor: Steven Wayne Counts, Indianapolis, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/679,435

(22) Filed: Feb. 27, 2007

Related U.S. Application Data
(60) Provisional application No. 60/776,868, filed on Feb. 27, 2006.

(51) Int. Cl. G01N 35/00

(52) U.S. Cl. 436/43

(57) ABSTRACT

The present invention provides an apparatus and method for sampling a metal working fluid and dispensing a corrective fluid to adjust the fluid in a tank or reservoir from which the sample was drawn. The apparatus, which in certain embodiments is transportable, includes an inlet configured to receive a fluid sample from a reservoir, a measuring station configured to determine at least one parameter of the fluid sample, a dispensing station configured to select a type and amount of fluid(s) to be added to the metal working fluid to restore its desired parameters, and an outlet configured to dispense the corrective fluid. The inventive apparatus provides an advantageous computerized comparison of the contaminates and concentrations of key constituents in a sample fluid against desired operating parameters and dispenses a corrective fluid, which, when added to the reservoir from which the sample fluid was drawn, corrects the adverse conditions of that fluid.

### RELATED APPLICATIONS

This application claims priority to U.S. Provisional Patent Application Ser. No. 60/776,868, filed Feb. 27, 2006, the entire disclosure of which is hereby incorporated herein by reference.

### BACKGROUND

Metal working fluids (“MWFs”) are industrial coolants and lubricants used to reduce friction and heat generated during machining, grinding and fabrication operations of metal products and to lubricate various parts during metal working operations. The fluids prolong the life of machines, carry away metal chips and protect the surfaces of the metal being processed. There are three main types of MWFs: insoluble fluids (straight or neat oils), soluble oils (oil in water emulsions) and synthetic fluids. These fluids can include additives such as corrosion inhibitors, emulsifiers, anti-foaming agents, preservatives and biocides. The formula used depends on the raw material or cutting operation to be carried out. Examples of the processes in which MWFs are used include can making, metal rolling, punching, sheet bending and the like. Typically, the processes recirculate spent fluid from the metalworking process through a filtration and equilibration system to remove metal fines, tramp oil, soils, etc. and return the fluid to the metalworking process.

### Controlling Chemical Concentration.

It has been found that, after checking chemical concentrations in the machinery that uses MWFs, chemicals are generally added without precise measurement. Specifically, in the event the MWF has been checked and determined to not fall within established operating parameters, an unmeasured amount of water and/or chemical concentrate is added. The fluid may (or may not) be re-checked at a later time/date to determine the impact of the addition. This approach invariably causes the fluid to go from too rich to too lean or vice versa. The resulting duplication of labor requirements for re-testing and re-adjusting chemicals can be costly. Additionally, a MWF having chemical concentrations not within the proper ranges can result in non-conforming parts, high tool failure rates, excessive chemical costs, and an increase in certain health risks associated with exposure to higher chemical concentrations.

Various instruments and methods are known for determining the concentration of water-soluble chemicals in aqueous solution. One example is a refractometer, which measures the amount and/or angle of light penetration through a lens when coated with a thin layer of the chemical being analyzed. The light is measured on a scale in the refractometer. To determine chemical concentration, the light measurement from the scale is multiplied by a mathematical equation specific to that particular chemical.

Although these instruments for measuring chemical concentration are readily available, there remains a gap in the industry between the results of the analysis and the corrective action needed and taken. With a refractometer, for example, the user will obtain a reading, but it will not convert this data into a quantitative concentration of the chemical of interest, nor will the instrument calculate the amount of chemical concentrate and/or water required to return the chemical reservoir to the target or optimum concentration.

While not a common practice, it is possible to manually calculate the exact amount of concentrate and/or water necessary to adjust the chemical concentration in a given chemical reservoir. An example of this calculation is as follows:

### Step 1. Determine the Chemical's Refractive Index (Specific to Each Chemical).

Mix a sample of chemical concentrate to a known concentration in water, e.g., in a graduated cylinder, mix 5 milliliters of chemical concentrate into 95 milliliters of water, resulting in a solution having a concentration of the chemical of 5%. Thoroughly mix to form an emulsion of the chemical concentrate and water. Place a small amount of the mixed fluid on the lens of a refractometer designed for the type of fluid being tested. For this example, assume the refract reading is 2.9. This indicates a refractive index of 1.724 (5% known concentration/2.9 measured refract=1.724 to 1 refractive ratio) This means that for each 1.0 reading on the refract scale, we know that the chemical concentration is 1.724%

### Step 2. Determine the Desired Chemical Concentration of the Machine Reservoir.

This is normally determined by various performance characteristics of the chemical itself and varies based on machine and application. For purposes of this demonstration, assume a 5% concentration is desired.

### Step 3. Determine the “Actual” Concentration of the Chemical Reservoir.

Place a small amount of the chemical from the reservoir onto the lens of the refractometer. Assume the refractometer scale reads 2.2 Now, the resulting concentration can be determined by multiplying the 2.2 reading by the 1.724 refractive ratio (established in Step 1 above) and the concentration is thus calculated as 3.79%.

### Step 4. Determine Chemical Reservoir Capacity.

The capacity of the chemical reservoir is calculated by measuring the height, width and length to determine area and volume. For example, a vessel having a height of 14 inches, a width of 24 inches and a length of 35 inches has a volume of 12,096 cubic inches. Since there are 231 cubic inches in a gallon, this equates to a 52.4 gallon capacity reservoir.

### Step 5. Determine Concentration Variance.

Compare the 5% desired concentration established in Step 2 to the 3.79% actual concentration established in Step 3, and the difference calculates to a deficiency of 1.21%

### Step 6. Determine Corrective Action Requirement.

The deficiency of 1.21% just calculated in Step 5 is multiplied by the reservoir capacity determined in Step 4, viz., 52.4 gallons. The result is 0.631 gallons of chemical concentrate is required to return the reservoir to the 5% desired concentration. In the event Step 5 reveals that the concentration is too rich, the appropriate amount of water addition necessary to lean the chemical to the desired concentration can be determined using similar mathematical equations. Further, it is also known in the art that calculations like the ones described above can be programmed into and executed by commercially available software programs, such as Microsoft Excel®. In addition to calculating coolant, such software has been used to calculate the amount of biocide and/or water that must be manually measured, e.g., by weight or volume, and then manually added to a given reservoir to restore the metal working fluid in that reservoir to its ideal operating conditions. As noted above, however, it is not common practice in the metal working industry that these calculations are actually carried out.

Indeed, a survey of twenty large metal working facilities revealed that the average company was operating with its water-based cutting fluids (coolants) 40% richer than the manufacturer's suggested concentration. This is primarily due to continuous evaporation of water from the fluid without replacement. Assuming an average $150,000 in annual coolant purchases, the average metal working facility can save $60,000 per year by properly maintaining the chemical concentration of its water based coolants.

Furthermore, improper control of chemical concentration is the single largest contributor to coolant related machining problems. When concentrations of the active chemicals become too low, tool life is shortened dramatically and rust and corrosion begin to take place on the machine tools and on the manufactured parts. Surface finish is impaired and microbial and fungus growth begins to flourish.

Similarly, when the metal working fluids become too rich, tool life is again shortened due to impairment of heat dissipation caused by increased fluid viscosity. Maintenance of machinery becomes a problem because heavy, sticky residue begins to accumulate on machine surfaces and tool holders. Operators begin complaining of dermatitis or respiratory problems as the chemicals become more concentrated. Excessive chemical consumption and related costs become significant issues.

Optimum concentration control significantly enhances the ability of the chemical to reduce friction heat by lubricating the cutting tool and work piece. Additionally, maintaining the chemical at the proper concentration enhances its ability to dissipate heat that would otherwise build up on the tool as well as the work piece. Maintaining consistent chemical conditions results in consistent and predictable heat transfer and expansion. This consistency allows manufacturing engineers and machinists to calibrate their machinery for consistent results in the critical tolerance machining operations.

### Chemical Contamination.

The metal working industry has generally paid little attention to contamination of metal working fluids. Instead, most companies change the fluid in coolant reservoirs when the coolant becomes rancid, producing unpleasant odors, or when solids build up in the reservoirs to the point that pumps become clogged and coolant flow to the machine is impaired. Little concern is focused on the following issues:

### Bacteria/Mold

Problems associated with microbial growth in metal working fluid include degradation of the coolant supply; drop in pH; emulsion instability; potential health risks including skin irritation and dermatitis, among others; generation of foul odors; increased corrosion and staining of the parts produced; and shortened tool life.

pH

pH (i.e., a measure of a liquid's acidity or alkalinity) is an important factor in managing MWFs. When bacteria levels become too high, the bacteria create an acidic byproduct, causing the pH to drop. When the pH falls to a level in which the MWF becomes mild to moderately acidic, the coolant becomes corrosive to ferrous metals, causing rust and corrosion of the work piece, tool holders and other machine surfaces. Normally, when the pH becomes too high, it is the result of cross contamination by high alkaline chemicals. When the pH of a MWF is too high, it attacks non-ferrous metals, causing corrosion, pitting and staining. Additionally, high pH levels are harsh on human skin tissue, causing irritation, including dermatitis.

### Total Dissolved Solids (TDS)

Most coolants vary in their susceptibility to TDS, with critical thresholds normally ranging from approximately 2,500 to 6,000 ppm. When TDS levels reach the critical threshold of a particular coolant, the coolant normally looses its ability to remain emulsified (e.g., an emulsion of water droplets suspended in oil breaks into two separate phases), in which event the effectiveness of the MWF significantly decreases. Additionally, high TDS levels create a high level of conductivity in the metal working fluid. High levels of conductivity can create an environment in which electrolysis caused by dissimilar metals is accelerated, causing corrosion, pitting and staining.

### Tramp Oil Contamination

Tramp oil, also known in the art as “sump oil,” is unwanted oil that is created as a byproduct of metalworking operations, typically originating as hydraulic fluids or lubricating oils that seep into the coolant mixture. It has been found that dramatic reductions in tool life result from excessive tramp oil contamination in metal working fluids. Additionally, tramp oil is a primary food source for bacteria, causing foul odors, shortened sump life and other bacteria related concerns, as previously described.

### Solids Contamination

Excessive solids in the coolant supply can result in a number of machining problems including clogged coolant lines and pumps; tool holders that fail to release; poor surface finish; inability to maintain critical machining tolerance; and excessive machine and tool wear.

An easy to operate and efficient means to achieve optimum concentrations of active chemicals in MWFs as well as controlling the abovementioned contaminants, among others, is thus desirable.

### SUMMARY OF THE INVENTION

The present invention provides an advantageous computerized comparison of the contaminates and concentrations of key constituents in a sample fluid against desired operating parameters and dispenses a corrective fluid, which, when added to the reservoir from which the sample fluid was drawn, corrects the adverse conditions of that fluid. The invention eliminates “guess work” in maintaining MWF's and closes the implementation gaps noted above. The present invention is useful for the treatment of multiple reservoirs that use MWF's, but one of ordinary skill in the art would readily recognize various other applications for these teachings within the spirit and scope of this disclosure.

In one form thereof, the present invention provides a method of operating a transportable analysis and dispensing unit of the type having an inlet configured to receive a fluid sample from a machine, an analysis unit configured to determine at least one parameter of the fluid sample, and an outlet configured to dispense a corrective fluid. The method comprises obtaining a fluid sample from a first reservoir and depositing the sample in the inlet of the unit. The unit automatically determines a parameter of the fluid sample and automatically prepares a corrective fluid based upon the determined parameter. The corrective fluid is deposited into the first reservoir and thereby substantially restores the parameter of the fluid in the reservoir to its desired value.

In exemplary forms of this inventive method, the valves and plumbing of the unit are then purged with rinse water and the unit is transported to a second machine, whereupon the steps just described are repeated. In another exemplary embodiment, at least two parameters of the fluid sample are determined or measured and the unit automatically prepares the corrective fluid based on the two determined parameters. A wide variety of parameters of the sample fluid can be measured, and correcting their levels and concentrations can be addressed by the corrective fluid that the unit produces. In exemplary embodiments, the parameters to be measured include pH, chemical concentration, total dissolved solids, dissolved oxygen, suspended particles, oil concentration, temperature and bacteria.

In another exemplary embodiment, the method includes transporting the unit to several reservoirs (of machines that use various metal working fluids) in a workplace. The identity and various desired operating parameters for the fluid in each reservoir are pre-programmed into the unit as part of initial preparation and stored. According to the inventive method, during use, the identity of each reservoir (or machine having the reservoir) is entered by the user before performing the method steps outlined above. In this manner, the invention provides an innovative method for automatically correcting the concentrations of various constituents in the metal working fluids of several machines in a facility.

In another form thereof, the present invention provides an apparatus for analyzing a sample fluid and dispensing corrective fluid. The apparatus includes a sample fluid inlet. A measuring station is fluidly connected to the sample fluid inlet and is configured to measure a parameter of the sample fluid being tested. A computer is in communication with the measuring station and includes stored information concerning at least two reservoirs which use fluid that periodically requires addition of corrective fluid thereto. The computer is programmed to determine an amount or type of corrective fluid to be dispensed based upon data provided to the computer from the measuring station and the stored information. The unit also includes a dispensing station in communication with the computer and configured for dispensing corrective fluid based upon information received from the computer.

In an exemplary form thereof, the measuring station includes at least one meter configured to measure one or more of pH, chemical concentration, total dissolved solids, dissolved oxygen, suspended particles, oil concentration, temperature and bacteria. In further exemplary embodiments, the measuring station includes at least two meters configured to measure two or more of pH, chemical concentration, total dissolved solids, dissolved oxygen, suspended particles, oil concentration, temperature and bacteria. In this embodiment, the measuring station includes a manifold in fluid communication with the sample fluid inlet and a series of meters downstream from and in fluid communication with the manifold. The dispensing station in exemplary embodiments includes several tanks fluidly connected to a dispensing manifold. Each tank has a valve associated therewith, and the valves are linked to and operable by the computer. The unit may include a human machine interface (HMI) linked to and in communication with the computer. The HMI is typically configured for input by a user of information such as log-in information and the selection of the machine to be serviced. The HMI can also display operator alerts.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a perspective view of a chemical dispensing unit in accordance with one embodiment of the present invention;

FIG. 2 is an exploded perspective view of the chemical dispensing unit of FIG. 1;

FIG. 3 is a perspective view of the interior of a panel of the unit of FIG. 1, showing valves and piping;

FIG. 4 is a flowchart illustrating the apparatus and method of an embodiment of the present invention;

FIG. 5 is a flowchart illustrating in more detail the apparatus and method of operation of an embodiment of the present invention;

FIG. 6 is a flowchart illustrating the method of operation of an embodiment of the present invention, emphasizing the interface between the system and the user; and

FIG. 7 is a block diagram illustrating an embodiment of the present invention in which a stationary unit services multiple reservoirs in a facility.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

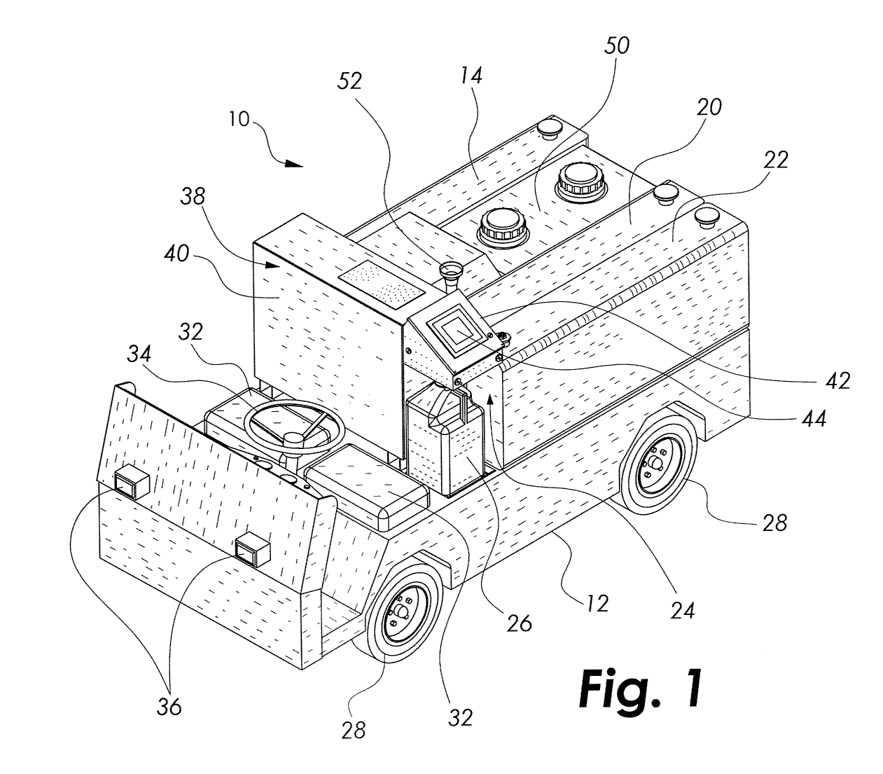

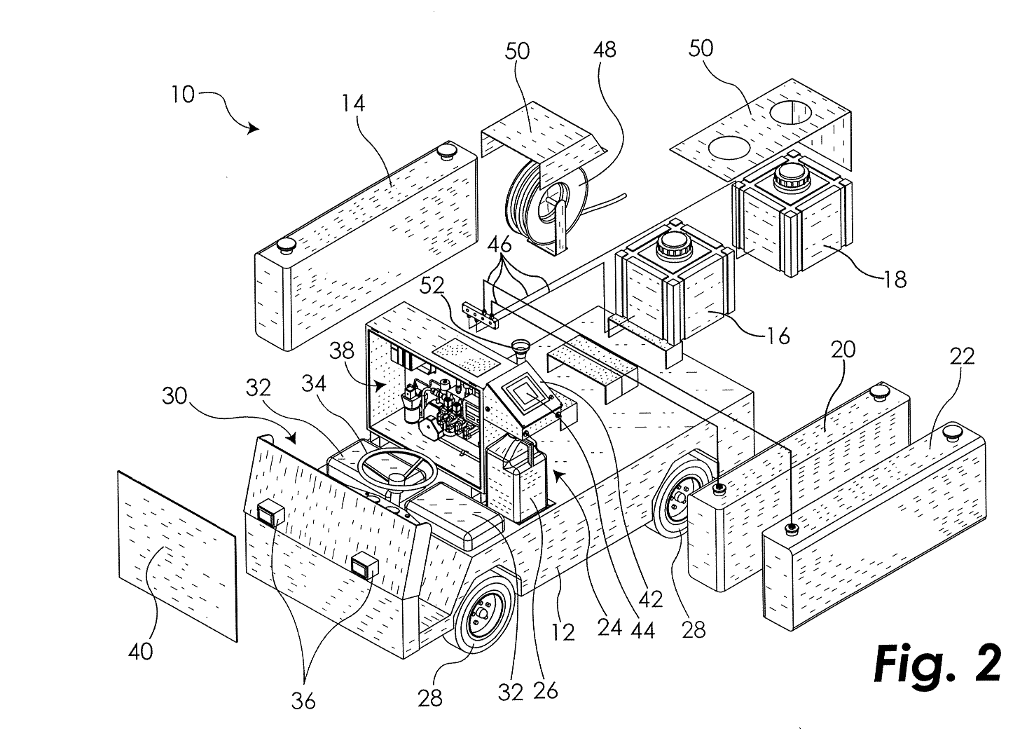

Turning now to FIGS. 1 and 2, mobile chemical dispensing apparatus or unit 10 includes a base or frame 12 to which is mounted several tanks 14, 16, 18, 20 and 22. A wide variety of tanks are suitable, one such tank being available from Park Plastic, part no. SP0012RT, 12 gal. Unit 10 includes a dispensing station 24 that includes a removable container 26 into which a precise amount of corrective fluid with a desired concentration of active chemical(s) is dispensed, as described in further detail below. Unit 10 is mobile, having wheels 28 and a cab 30 including removable seats 32 and steering wheel 34. Although unit 10 is shown with 4 wheels, other transportation means are possible, including rails, overhead crane and the like. Lights 36 allow the unit to be safely manoeuvred in dark or poorly lit conditions. A panel 38 having a removable or openable lid or cover 40 is mounted behind seats 32, and a human machine interface (“HMI”) 42 having a screen 44 is mounted on the side of panel 38. As shown in FIG. 2, various lines 46 fluidly connect the various tanks to the panel 38. An optional hose 48 may be provided with a connection to a water tank for auxiliary functions. For example, a machine may have a reservoir whose water concentration has obviously dipped far below its ideal level, in which event the hose may be used to “top off” the reservoir. As shown in FIG. 2, various covers 50 can be provided to protect the tanks and improve the aesthetics of the unit. Finally, an inlet port 52 is provided to allow the operator to deposit a MWF sample for analysis by unit 10.

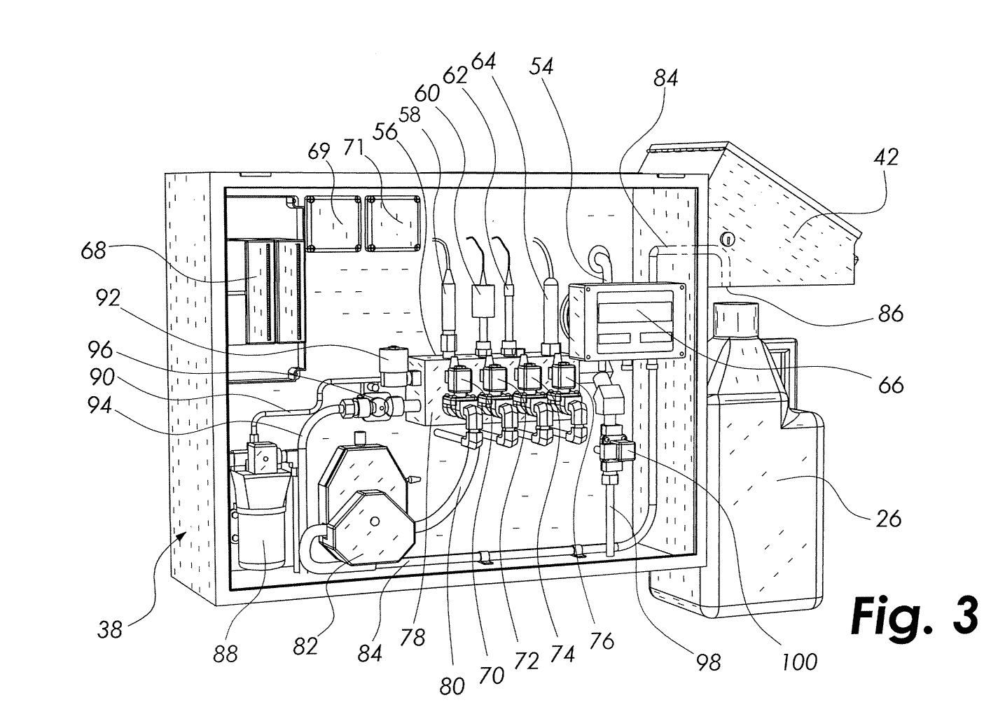

As shown in FIG. 3, inlet port 52 leads to a pipe or tube 54 that extends into analytical manifold 56, which in turn is in fluid communication with several meters 58, 60, 62, 64 and refractometer 66. One of skill in the art would recognize a wide variety of commercial sources for these meters. For example, a refractometer suitable for refractometer 66 is available from the Cole Parmer Co., part no. 3576-CM-780; suitable TDS transmitters and probes are available from Cole Parmer, part nos. A-35150-20 and A-35150-50, respectively; and suitable pH transmitters and probes are available from Cole Parmer, part nos. A-56717-00 and A-27001-90, respectively. These meters can test the MWF for any of a wide variety of parameters, as discussed in further detail below. The meters are wired to and input the computer 68, which is provided in the illustrated embodiment as a programmable logic controller (“PLC”), which in turn is wired to HMI 42, such that information relating to the parameters measured by the meters can be displayed to the operator. Stations 69 and 71 include controls that allow calibration of certain of the meters, as described in more detail below. Stations 69 and 71 can, optionally, be located within the HMI panel 42.

Briefly returning to FIG. 2, fluid lines 46 from the various tanks are fed into the panel 38 and are shown as terminating into solenoid valves 70-76 shown in FIG. 3, which in turn are fluidly connected to dispensing manifold 78. Actually, in the illustrated embodiment, the analytical manifold 56 is located behind manifold 78 as indicated by the lead lines for reference numerals 56 and 78, although only a single rectangular housing for both manifolds can be seen in FIG. 3. Based upon the information relayed from the meters to the PLC, one or more of the solenoid valves may be actuated to allow a desired amount of a chemical from one of the tanks mounted on the back of the truck to be pumped. In this connection, manifold 78 has an outlet tube 80 which is fed through peristaltic pump 82, which meters a desired amount of chemical therethrough. A pump that is suitable for use in this embodiment is a Cole Parmer, Model C-77601-00. At the outlet side of pump 82, the tube 80 is coupled to another tube or pipe 84, which spans the bottom of the panel, turns up the sidewall of the panel, and then exits and terminates in a dispensing outlet 86 in HMI 42 to deposit chemical in container 26.

Still referring to FIG. 3, a pump 88 is coupled to a water supply tank, which, e.g., may be provided as one of the tanks on the back of the unit 10. Line 90 having operable solenoid valve 92 is fluidly connected to the manifold 56 to clean the meters and associated lines. Similarly, line 94 having operable solenoid valve 96 is fluidly connected to manifold 78 to purge the solenoid valves 70-76 and associated plumbing. A drain line 98 having a solenoid 100 is connected to a waste tank for depositing used rinse fluid from the analytical manifold 56 and meters. In the illustrated embodiment, the spent rinse fluid from the dispensing manifold passes through pump 82 and is dispensed as part of the corrective fluid, as discussed in more detail below.

Unit 10 in the embodiment illustrated in FIGS. 1 and 2 is designed to be highly mobile and capable of servicing multiple machines and/or chemical reservoirs, even though each machine may require dissimilar chemicals and/or operate under completely different parameters. In this connection, the computer or PLC 68 includes software that is fully integrated with unique dispensing equipment and technology designed to improve the management of water soluble chemicals, reduce labor and chemical costs associated with managing these fluids and provide important archived data for trouble shooting, cost allocation, inventory control and environmental reporting. Although this disclosure describes an application of unit 10 in the metal working industry, one of skill in the art would easily appreciate that the computer can be programmed to support the management of water soluble chemicals used in a variety of industries.

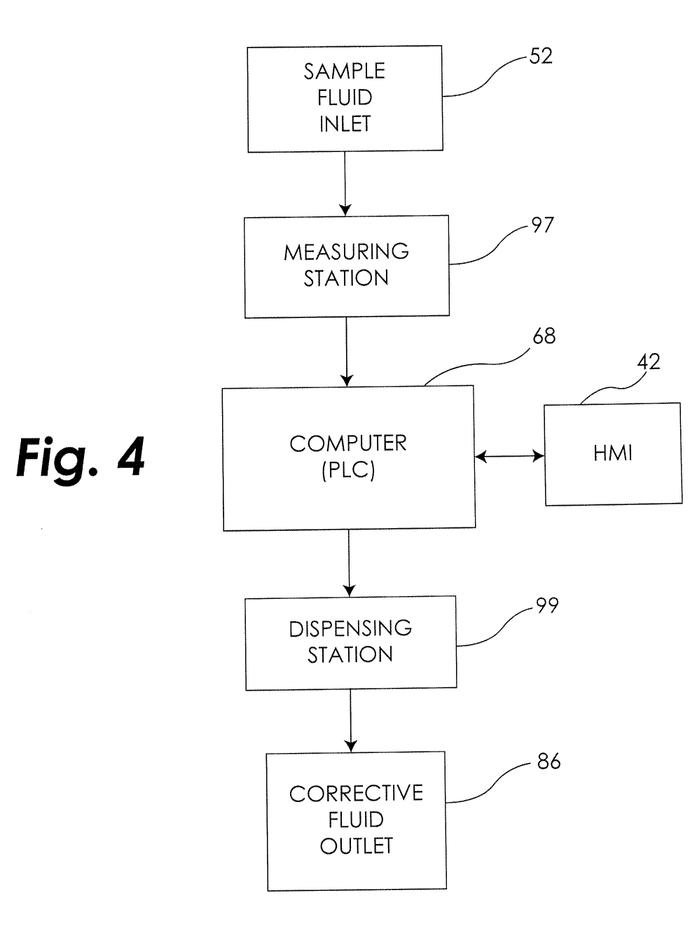

FIG. 4 illustrates an overview of the inventive unit 10 and method of operating the same. As discussed elsewhere, unit 10 includes a sample fluid inlet 52 configured to receive a fluid sample from the reservoir of a machine that uses a metal working fluid, as depicted in FIG. 4. A measuring station 97 is fluidly coupled to the sample fluid inlet and is configured to determine at least one parameter of the fluid sample. For example, the measuring station 97 can include an analytical manifold 56 and various meters such as illustrated with respect to FIG. 3, In other embodiments, measuring station 96 may include only a single meter and no manifold. In any event, a fluid sample is drawn from a reservoir of a machine that uses, e.g., metal working fluid, and is deposited in the inlet 52. This sample fluid is analyzed by the measuring station 97 to determine a parameter of the fluid sample, such as pH, tramp oil concentration or the like. The measuring station is in communication with the computer or PLC 68, and the parameter measured by the measuring station is communicated to the PLC. In exemplary embodiments, the PLC is programmed with the ideal operating parameters of each machine that unit 10 services. More specifically, the computer is pre-loaded with data concerning the chemicals and the machines the chemicals support, including but not limited to the following:
The machine or reservoir name, number or other identifying factor.
The type of chemical(s) in the reservoir
The ratios of refractive index scale, to percent concentration for each chemical
The reservoir's fluid capacity and/or height, width and length measurements
Concentration of pre-mixed (if any), chemical additives to be stored on the dispensing unit.
Desired or target chemical to water ratio or concentration of each chemical, in each machine reservoir
Desired or target pH range
Desired or target dissolved oxygen (DO) level
Desired or target total dissolved solids (TDS) level
Desired or target conductivity level
Desired or target suspended solids
Desired or target temperature range
Desired or target oil range
   Accordingly, upon the measured parameter being input to computer 68, the computer implements its program and determines the amount and type of corrective fluid(s) that needs to be added to the reservoir of the machine to restore the desired operating parameters. The concentration of the constituents of the sample fluid and the corrective measures necessary can be displayed by HMI 42.

Once the determination of corrective fluid is made, the computer sends a signal to the dispensing station 99. In one embodiment, the dispensing station may be configured as shown in FIG. 3, including a dispensing manifold 78 that is fluidly coupled to several tanks by means of solenoid valves 70, 72, 74 and 76. In other embodiments, the dispensing station may include a single tank. In still other embodiments, the dispensing station may include several tanks, each having a particular chemical, and each having a fluid line originating at the particular tank and terminating at the fluid outlet. In any event, the signal from the computer opens one or more valves that are in fluid communication with one or more tanks containing fluids, respectively, and fluid is drawn therefrom by means of a pump(s), such as pump 82 shown in FIG. 3. The corrective fluid, which may be a mixture of several different fluid components drawn from different tanks, exits the corrective fluid outlet 86, and is deposited in the reservoir of a machine to restore the metal working fluid to its proper operating parameters. While FIGS. 1 and 2 illustrate a removable container 26 that is used to collect the corrective fluid and then transport it to the reservoir, one of skill in the art would recognize that the corrective fluid may be dispensed from unit 10 directly into the reservoir by, e.g., a hose (not shown). Advantageously, with this single dose of corrective fluid automatically prepared as just described, the fluid in the reservoir is substantially restored to its ideal operating parameters.

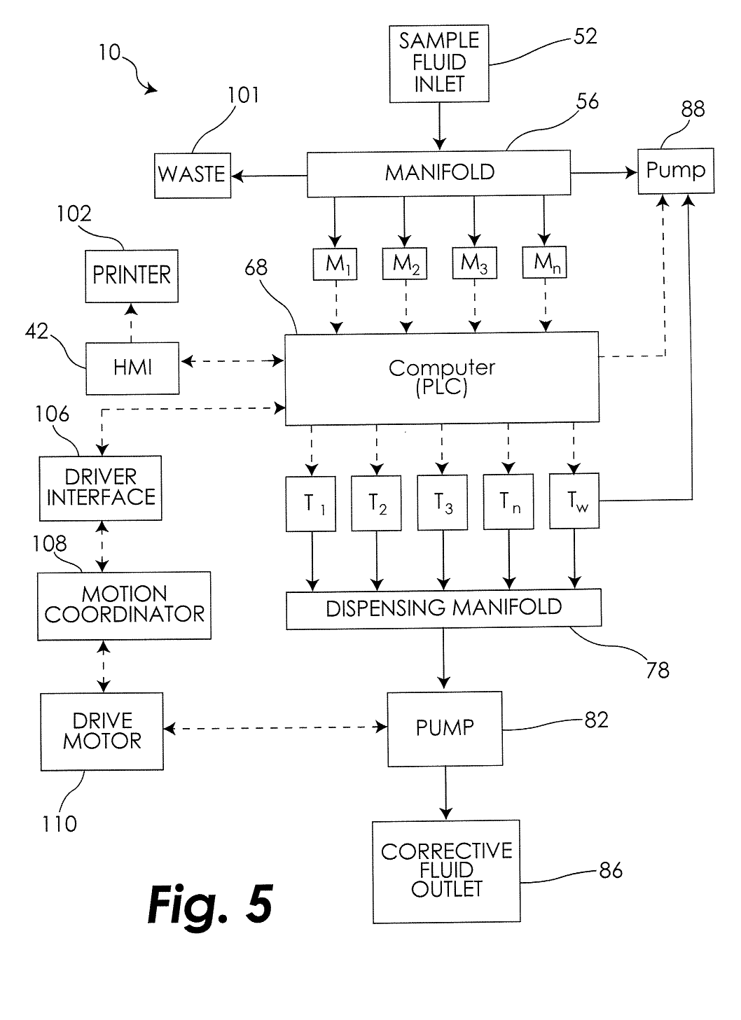

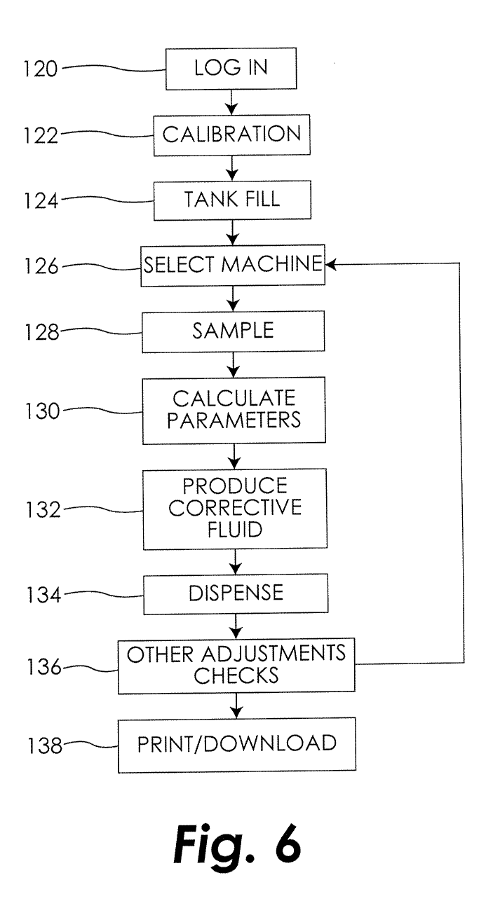

A more detailed schematic of the unit and method of operation according to an exemplary embodiment of the invention can be appreciated with reference to FIGS. 5 and 6. As a first step 120, the operator of unit 10 must “log-in” by entering information such as a user id and password, as is known in the art. This user information can be entered directly by touching the screen 44 (FIG. 1) of the HMI 42.

Next, the operator or user must calibrate unit 10, as shown in block 122 of FIG. 6. In the calibration step, the user deposits a control solution having a known parameter in inlet 52 (FIG. 5). For example, if the meter being calibrated is the pH meter, then the control solution has a known pH, e.g., 7. Embodiments of the present invention employ a novel “offset” program in which minor variations can be corrected without actually recalibrating the various meters. For example, if the meter reads a pH of 7.2 and this reading is input into the PLC, whereas the control solution has a known pH of 7.0, the PLC is programmed in exemplary embodiments to automatically adjust all pH readings downward by 0.2 units, the assumption being that the pH meter is reading 0.2 pH units too high across the entire range of the pH's of the various fluids it is going to analyze. This preprogrammed “offsetting” technique is automatic, and it advantageously avoids the user having to calibrate the meter itself, e.g., by opening compartments 69 or 71 and adjusting a calibration knob. While small variance in meter readings versus known control solutions can be corrected by the offsetting technique just described, larger variances would result in the HMI displaying a warning, requiring an actual re-calibration. Unit 10 can be programmed such that actual calibrations can only be performed by an authorized service person, having a user id and password that allows greater access to the functionality of unit 10.

Once the calibration step is completed, the tanks of the unit are filled, as indicated in block 124 of FIG. 6. In this step, the HMI 42 prompts the user to fill each tank and indicate the same by, e.g., depressing a “filled” icon on the HMI. Advantageously, in exemplary embodiments, there need be no meter on each tank or any other such communication between the tanks and the PLC. Instead, the PLC is programmed with the capacity of each tank and accepts as true that the tank is filled when the same is entered into the HMI by the operator. The PLC can calculate the amount of fluid being dispensed as described below.

To analyze and dispense fluids from unit 10, the operator or user enters the identifying machine name or number associated with the chemical reservoir into the programmable logic controller (PLC) 68, or chooses the same from a pre-programmed list, as indicated in block 126. This can be done directly, or in exemplary embodiments and as shown in FIG. 5, the HMI 42 is provided having a display 44 (see FIG. 1). The display may include a touch screen, thus allowing the user to enter the necessary information. As another option, the reservoir name or identifying number can be represented on a bar coded, magnetic or electronic tagging device attached to or in the proximity of the machine or reservoir.

In either case, when the user inputs the data into the PLC, the PLC will in turn locate the reservoir in the software program, thereby accessing all relevant information pertaining to the fluid in the machine reservoir, including chemical type and all desired operating parameters of the fluid. All of this information is obtained and input into the PLC as part of the initial preparation of unit 10 for service.

The operator then attains a sample of the fluid from the reservoir of the machine whose metal working fluid is to be tested and corrected and introduces the sample fluid into inlet port 52 of unit 10. This is depicted in block 128 of FIG. 6. As shown in FIG. 5, the sample fluid passes through manifold 56 and a series of measuring instruments depicted in FIG. 5 as M₁, M₂, M₃ and Mₙ. The subscript “n” of course makes clear to the person of ordinary skill in the art that the number and type of measuring instruments provided in accordance with these teachings may vary widely, depending upon the particular application. The measuring instruments are depicted in FIG. 3 as meters 58, 60, 62 64 and 66. Measuring instruments may include the following: refractometer; dissolved oxygen meter; pH meter; TDS meter; suspended solids meter; conductivity meter; and thermometer.

The measuring instruments send milliamp or millivolt signals (electrical signals) to the PLC either directly or through a transmitter. The signal is interpreted by the PLC to generate a numerically equivalent code. This code is then analyzed against the pre-established target parameters. Optionally, each parameter that is calculated can be displayed on the HMI, e.g., “pH=7.4.” Further, through a series of mathematical algorithms, the PLC calculates the exact amount of each chemical component of the corrective fluid (biocide, pH buffer, water, concentrate, etc.) that is necessary to adjust the chemicals in the reservoir to the pre-established, target operating parameters. All of these calculations are done automatically as part of this step (block 130, FIG. 6), based upon the individual information entered into the PLC and stored during the initial preparation of unit 10, as described above.

Next, as depicted in blocks 132 and 134 of FIG. 6, a corrective fluid is prepared and dispensed into a reservoir to correct the operating parameters of the metal working fluid contained in that reservoir. To accomplish this, the PLC sends electronic signals to the dispensing station, shown in FIG. 5 as including dispensing manifold 78 and tanks T₁, T₂, T₃, Tₙ and T_{w}. Again, one of ordinary skill in the art will recognize that any of a wide variety of tanks containing various fluid components can be provided in accordance with these teachings. Generally, it is desirable to include a tank having rinse water or other rinse fluid as indicated by tank T_{w}. Each tank has a respective solenoid valve (shown in FIG. 3) operably linked to the PLC, and the PLC can selectively open these valves to select tanks from which fluid is to be drawn. The dispensing station also includes a pump 82, which in an exemplary embodiment is a peristaltic pump. The unit thus selectively activates the appropriate pump(s) and electronic control valves necessary to dispense the exact amount of each chemical necessary to return the chemical concentrations and other parameters (such as pH) in the machine's reservoir to their desired parameters.

More particularly, the illustrated embodiment utilizes a highly accurate peristaltic pump system to meter the fluids that become part of the corrective fluid that is dispensed. First, as noted, the PLC determines the amount of each chemical that is needed from the various tanks. Then the PLC calculates the number or revolutions (or partial revolutions) of the peristaltic pump 82 in order to achieve the desired amount of the particular fluid. An encoder attached to and in communication with the pump motor, counts the revolutions of the pump motor and provides information to the PLC concerning the location of the pump relative to the revolution count. As shown in FIG. 5, the pump 82 is powered by a step motor 110 (FIG. 5), which is controlled by the PCL 68 by driver interface 106. Specifically, computer 68 is connected to a driver interface 106 (Intelligent Motion Systems part no. OPT-140), which is connected to a motion coordinator 108 (Intelligent Motion Systems part no. P-136-MC-206X), which in turn is connected a drive motor 110 (Intelligent Motion Systems part no. M-2222-6.0-ED-400) having a stepping drive (not shown) (Intelligent Motion Systems part no. IB-106), which drives pump 82. One of skill in the art would readily recognize other configurations to control pump 82.

Advantageously, the pump can be controlled in fractions of a revolution for dispensing minute amounts, and can also be controlled at variable revolutions per minute, depending upon the amount to be dispensed. For example, in the case of biocide, the pump may be required to dispense a very small amount, e.g., required to achieve 75 ppm in a 25 gallon sump, which is 0.001875 gallons. This may be immediately followed by pumping 15 gallons of coolant concentrate. It is envisioned that a variety of fluid control methods other than the peristaltic pump just described could be employed to meter the fluids, e.g., timed solenoid valves, flow meters, motor controllers and the like.

In view of the foregoing discussion, when unit 10 is configured to draw several chemical components from different tanks to make up the corrective fluid, the particular order in which the constituents are drawn can be advantageous. For example, due to concerns for chemical compatibility, it may be most desirable to draw biocide first, followed by pH adjuster, followed by coolant concentrate, and lastly, water or other rinse fluid. Similarly, since the plumbing also needs to be rinsed, adding water as a last step is advantageous.

One of skill in the art should appreciate that the amount of water that is used in a particular reservoir is not a variable that must be controlled as accurately as other additives. For example, if the amount of water in the corrective fluid is 0.2 gallon instead of 0.1 gallon, the effect on the concentration of the remaining constituents in the reservoir to which the corrective fluid is added will be negligible. Therefore, extra water (or other rinse fluid) can be added to the corrective fluid to purge the dispensing station and then added to the corrective fluid without adversely affecting the desired concentration of any of the constituents of the reservoir. Thus, while the PLC is capable of being programmed to consider and compensate for the effect of the rinse fluid, compensation is generally not required; therefore, in this illustration, the PLC need not calculate or account for the amount of rinse water used to purge the dispensing unit.

With further reference to FIG. 5, a pump 88 is connected to tank T_{w} and pumps rinse water through manifold 56 and the meters that are fluidly connected thereto. The spent rinse water can then be discarded into waste tank 100 as shown. As discussed above, pump 82 is also fluidly connected to the dispensing manifold 78 (through solenoid valve 96 as shown in FIG. 3, which is fluidly connected to tank T_{w}) such that the dispensing manifold can also be purged after each use. With reference to FIGS. 3 and 5, water from tank T_{w} is used to purge any remaining chemical(s) from manifold 78, line 80, pump 82, line 84 and is then deposited into container 26 (FIG. 1).

After the corrective fluid is dispensed, the HMI can be configured to prompt the user to check other conditions of the metal working fluid in the reservoir, such as whether oil needs to be skimmed from the fluid in the reservoir, addressing build up of chips in the sump, or the like. This is indicated in step 136 in FIG. 6. Advantageously, all of these auxiliary checks can be input into the PLC, which enables a complete report of the conditions of a particular reservoir, and the metal working machine of which it is a part, to be prepared.

Thus, the software program of the PLC can maintain a record of all chemical conditions, including corrective action requirements and fluids dispensed. These records can be downloaded periodically, e.g., to an independent computer (not shown) or printer 102 (FIG. 5), to be further analyzed, as shown at block 138 of FIG. 6. The reports can be formatted or displayed in any report or summary formats, as is know in the art. The records can be used for chemical trouble shooting, trend analysis, statistical process control (SPC), tracking chemical usage, inventory control, cost allocation, environmental reporting, as well as other useful analysis and reports.

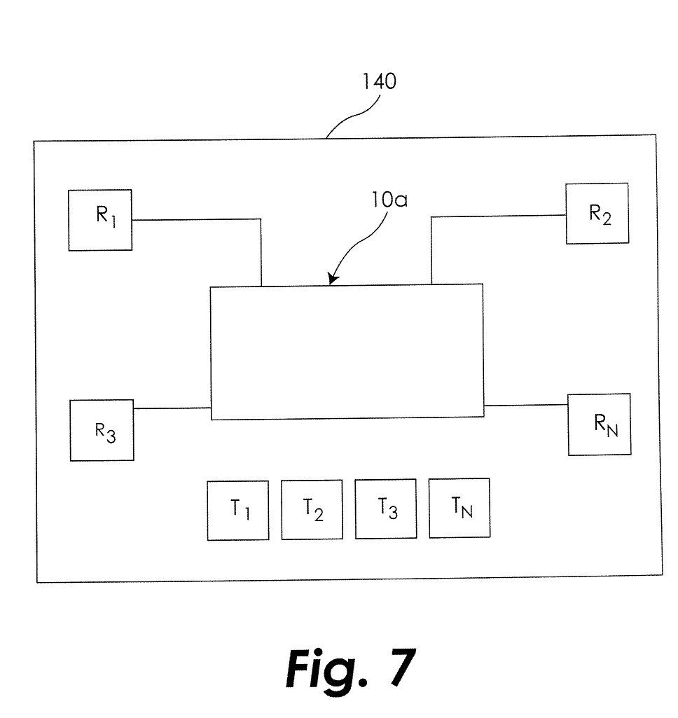

While an exemplary embodiment of the present invention has been described above (with reference to FIGS. 1 and 2) as a mobile apparatus 10, it should be understood that the fluid in several reservoirs (from different machines using various metal working fluids) can be corrected using the principles of this disclosure with a stationary apparatus. Turning to FIG. 7, stationary apparatus 10a can be positioned, e.g., in a facility 140 that includes several machines, each having its own reservoir. The reservoirs are depicted in FIG. 7 as R₁, R₂, R₃ and Rₙ. Unit 10a may be fluidly connected to any number of tanks each having a particular fluid configured to correct a particular parameter in one or more of the reservoirs. To implement this stationary embodiment, the outlet of unit 10a can, e.g., include a manifold that is operable by the computer and which can open a valve to selectively deposit fluid into one of the pipes leading to reservoirs R₁, R₂, R₃ and Rₙ. Similarly, each reservoir may have a sample fluid line connected to a manifold that is in turn connected to an inlet of unit 10a for sampling. One of ordinary skill in the art would appreciate other configurations and variations of these teachings for configuring a stationary or mobile apparatus within the scope and spirit of this disclosure.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating an analysis and dispensing unit of the type having an inlet configured to receive a fluid sample from a reservoir, a measuring station configured to determine at least one parameter of the fluid sample, and a dispensing station configured to dispense a corrective fluid, the method comprising:
(a) obtaining a fluid sample from a first reservoir and depositing the sample in the inlet of the unit;
(b) using the unit to automatically determine a parameter of the fluid sample and automatically prepare a corrective fluid based upon the determined parameter; and
(c) depositing the corrective fluid into the first reservoir and thereby substantially restoring the parameter of the fluid in the reservoir to its desired value.

2. The method of claim 1, further comprising transporting the unit to a second reservoir and repeating steps (a) to (c) with the second reservoir.

3. The method of claim 2, further comprising purging the unit with rinse fluid before repeating steps (a) to (c).

4. The method of claim 1, wherein step (b) comprises determining at least two parameters of the fluid sample and preparing the corrective fluid based upon the two determined parameters.

5. The method of claim 1, wherein step (b) comprises determining one or more of pH, chemical concentration, total dissolved solids, dissolved oxygen, suspended particles, oil concentration, temperature and bacteria.

6. The method of claim 1, wherein the sample fluid comprises a metal working fluid.

7. The method of claim 1, further comprising inputting the identity of the first reservoir into the unit before step (b).

8. The method of claim 1, further comprising displaying information about the sample fluid or the corrective fluid with the unit.

9. The method of claim 1, further comprising, before step (a), inputting in the unit desired operating parameters of a plurality of reservoirs having fluids to be tested and corrected.

10. The method of claim 9, further comprising inputting the identity of the first reservoir into the unit before step (b).

11. The method of claim 10, further comprising, after step (c), moving the unit to a second reservoir, inputting the identity of the second reservoir into the unit, and repeating steps (a) to (c) with the second reservoir.

12. The method of claim 11, further comprising purging the unit with rinse water before repeating steps (a) to (c).

13. The method of claim 1, wherein step (b) comprises drawing a plurality of component fluids in sequence and combining them to form the corrective fluid, wherein the sequence is determined at least in part by chemical compatibility.

14. The method of claim 1, further comprising purging the dispensing station with rinse fluid and dispensing the spent rinse fluid as part of the corrective fluid.

15. An apparatus for analyzing a sample fluid and dispensing corrective fluid, comprising:
a sample fluid inlet;
a measuring station fluidly connected to the sample fluid inlet and configured to measure a parameter of the sample fluid being tested;
a computer in communication with the measuring station and including stored information concerning at least two reservoirs which use fluid that periodically requires addition of corrective fluid thereto, the computer being programmed to determine an amount or type of corrective fluid to be dispensed based upon data provided to the computer from the measuring station and the stored information; and
a dispensing station in communication with the computer and configured for dispensing corrective fluid based upon information received from the computer.

16. The apparatus of claim 15, wherein the measuring station includes at least two meters configured to measure two or more of pH, chemical concentration, total dissolved solids, dissolved oxygen, suspended particles, oil concentration, temperature and bacteria.

17. The apparatus of claim 15, wherein the dispensing station comprises a plurality of tanks fluidly connected to a dispensing manifold, each tank having a valve associated therewith, the valves being linked to and operable by the computer.

18. The apparatus of claim 15, wherein the measuring station comprises a manifold in fluid communication with the sample fluid inlet and a series of meters in fluid communication with the manifold.

19. The apparatus of claim 15, further comprising a human machine interface (HMI) linked to and in communication with the computer, the HMI configured for input of information by a user.

20. The mobile apparatus of claim 19, wherein the HMI comprises a display.

21. The apparatus of claim 19, wherein the HMI comprises a printer.

22. The apparatus of claim 15, further comprising means to transport the apparatus from one reservoir to another.

23. A mobile apparatus for analyzing a sample fluid and dispensing corrective fluid, comprising:
a sample fluid inlet;
a measuring station fluidly connected to the sample fluid inlet and configured to measure a parameter of the sample fluid being tested;
a computer in communication with the measuring station and including stored information concerning at least one reservoir which uses fluid that periodically requires addition of corrective fluid thereto, the computer being programmed to determine an amount or type of corrective fluid to be dispensed based upon data provided to the computer from the measuring station and the stored information; and
a dispensing station in communication with the computer and configured for dispensing corrective fluid based upon information received from the computer.

24. The apparatus of claim 23, wherein the measuring station includes a meter configured to measure one or more of pH, chemical concentration, total dissolved solids, dissolved oxygen, suspended particles, oil concentration, temperature and bacteria.

25. The apparatus of claim 24, further comprising a tank configured to hold rinse fluid, the computer programmed to purge the dispensing station with rinse fluid and dispense the spent rinse fluid as part of the corrective fluid.

26. The apparatus of claim 23, wherein the dispensing station comprises a plurality of tanks fluidly connected to a dispensing manifold, each tank having a valve associated therewith, the valves being linked to and operable by the computer.

27. The apparatus of claim 23, wherein the measuring station comprises a manifold in fluid communication with the sample fluid inlet and a series of meters in fluid communication with the manifold.

28. The apparatus of claim 23, further comprising a human machine interface (HMI) linked to and in communication with the computer, the HMI configured for input of information by a user.

29. The apparatus of claim 23, further comprising wheels.
